(19) United States
(12) Patent Application Publication
(10) Pub. No.: US 2013/0308294 A1
(43) Pub. Date: Nov. 21, 2013

(54) Luminaire

(71) Applicants: TOSHIBA LIGHTING & TECHNOLOGY CORPORATION, Yokosuka-shi (JP); KABUSHIKI KAISHA TOSHIBA, Tokyo (JP)

(72) Inventors: Kenji Nezu, Yokosuka-shi (JP); Hiroshi Matsushita, Yokosuka-shi (JP); Yuichiro Takahara, Yokosuka-shi (JP); Makoto Otsuka, Tokyo (JP); Yasuhide Okada, Yokosuka-shi (JP); Hiromi Nara, Yokosuka-shi (JP); Erika Takenaka, Yokosuka-shi (JP)

(73) Assignees: Kabushiki Kaisha Toshiba, Tokyo (JP); Toshiba Lighting & Technology Corporation, Yokosuka-shi (JP)

(21) Appl. No.: 13/835,540

(22) Filed: Mar. 15, 2013

(30) Foreign Application Priority Data
May 16, 2012 (JP) 2012-112858

(51) Int. Cl. F21V 9/16; F21V 5/04; F21V 7/04

(52) U.S. Cl. CPC F21V 9/16; F21V 7/043; F21V 5/04
USPC 362/84; 362/296.05; 362/267

(57) ABSTRACT

According to one embodiment, a luminaire includes a substrate, a light-emitting section mounted on the substrate and including a light-emitting element, an outer frame body provided with a through-hole in a bottom surface, provided on the substrate to locate the light-emitting section in the through-hole, and made of an insulator, and a cylindrical reflector in the outer frame body, including a first opening end and a second opening end having an area larger than the first opening end, and provided on the bottom surface with the first opening end. A step is absent in at least one part of the part between an inner wall surface of the through-hole and an inner wall surface of the reflector. An area of a third opening end on the substrate side of the through-hole is smaller than an area of a fourth opening end on the reflector side of the through-hole.

### CROSS-REFERENCE TO RELATED APPLICATIONS

This application is based upon and claims the benefit of priority from the prior Japanese Patent Application No. 2012-112858, filed on May 16, 2012; the entire contents of which are incorporated herein by reference.

### FIELD

Embodiments described herein relate generally to a luminaire.

### BACKGROUND

In general, a luminaire (an LED lamp) mounted with an LED (Light Emitting Diode) module adopts a structure in which the LED module and a reflector are not in contact with each other. That is, a gap is present between the LED module and the reflector. Since the gap is present, if the inner wall of the reflector is coated with a metal film, a spatial distance between the reflector and the LED module is secured and insulation between the LED module and the reflector is secured. However, light emitted from the LED module escapes from the gap between the LED module and the reflector and light extracting efficiency of the luminaire is deteriorated.

### BRIEF DESCRIPTION OF THE DRAWINGS

FIG. 1A is an upper schematic perspective view of a luminaire according to a first embodiment;

FIG. 1B is a lower schematic perspective view of the luminaire;

FIG. 2A is a schematic sectional view of the entire luminaire;

FIG. 2B is an enlarged schematic sectional view of the vicinity of a light-emitting section of the luminaire;

FIG. 3 is a schematic perspective view of the vicinity of the light-emitting section of the luminaire;

FIG. 4 is a schematic plan view of the luminaire;

FIG. 5 is a schematic sectional view of a luminaire according to a reference example;

FIG. 6 is a schematic perspective view of the vicinity of a light-emitting section of a luminaire according to a second embodiment;

FIG. 7A is a schematic sectional view of a first example of the vicinity of the light-emitting section of the luminaire;

FIG. 7B is a schematic sectional view of a second example of the vicinity of the light-emitting section of the luminaire; and

FIG. 7C is a schematic sectional view of a third example of the vicinity of the light-emitting section of the luminaire.

### DETAILED DESCRIPTION

According to one embodiment, a luminaire includes: a substrate; a light-emitting section mounted on the substrate and including a light-emitting element; an outer frame body provided with a through-hole in a bottom surface, provided on the substrate to locate the light-emitting section in the through-hole, and made of an insulating member; and a cylindrical reflector housed in the outer frame body, including a first opening end and a second opening end having an area larger than the area of the first opening end, and provided on the bottom surface with the first opening end directed to the bottom surface side.

A step is absent in at least one part of the part between an inner wall surface of the through-hole and an inner wall surface of the reflector. The area of a third opening end on the substrate side of the through-hole is smaller than the area of a fourth opening end on the reflector side of the through-hole.

Embodiments are explained below with reference to the drawings. In the following explanation, the same members are denoted by the same reference numerals and signs. Explanation of the members explained once is omitted.

### First Embodiment

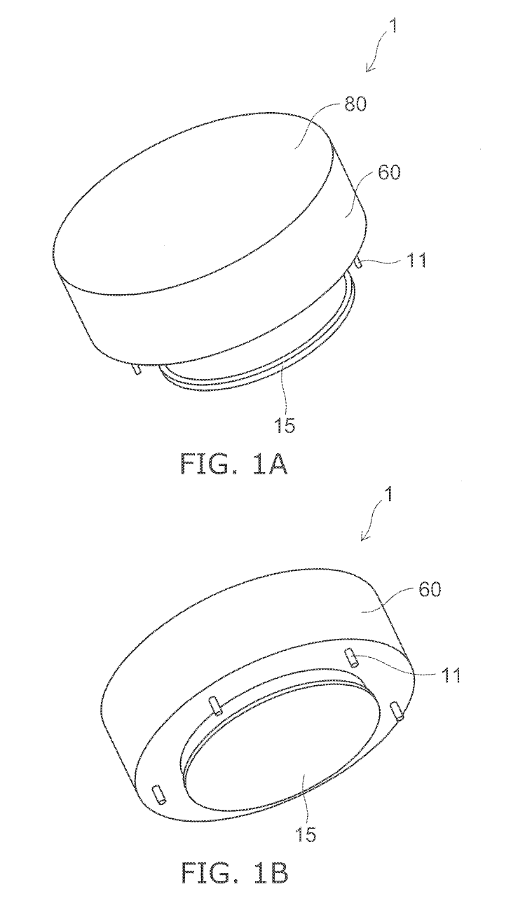

FIG. 1A is an upper schematic perspective view of a luminaire according to a first embodiment. FIG. 1B is a lower schematic perspective view of the luminaire.

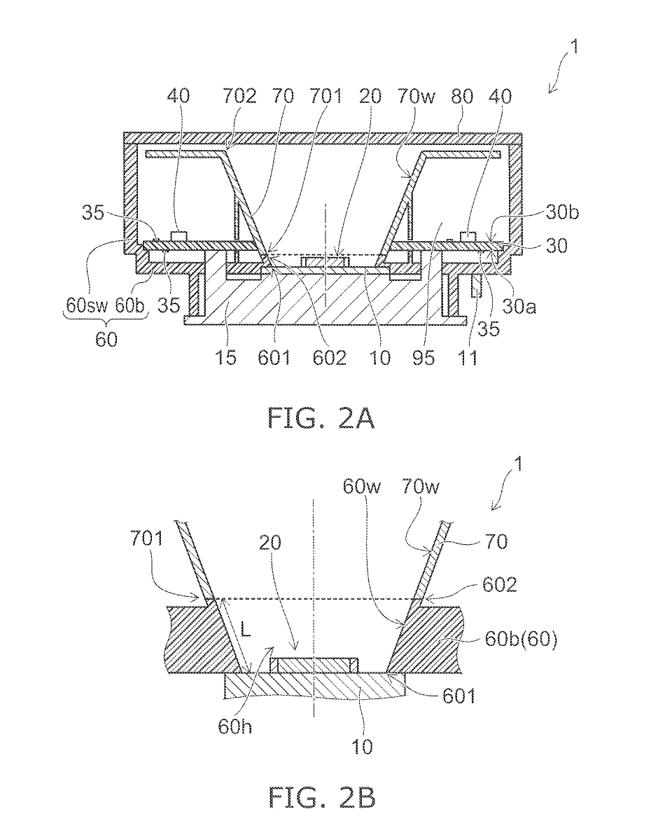

FIG. 2A is a schematic sectional view of the entire luminaire. FIG. 2B is an enlarged schematic sectional view of the vicinity of a light-emitting section of the luminaire.

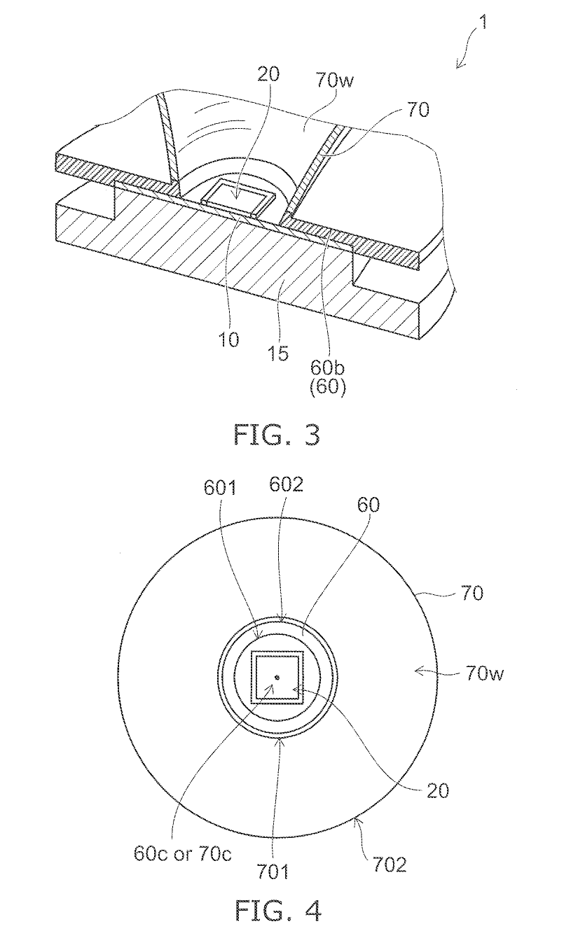

FIG. 3 is a schematic perspective view of the vicinity of the light-emitting section of the luminaire.

A luminaire 1 according to the first embodiment is an LED light engine (LLE) type. Here, the LED light engine means a luminaire which can be attached to an interface of the luminaire electrically or mechanically. The interface is, for example, a socket and so on. And, in embodiments, the self-powered LED light engine is explained. The LED light engine may be not the self-powered light engine. The luminaire 1 includes a substrate 10, a light-emitting section (a light source) 20 mounted on the substrate 10, an outer frame body (a housing) 60 provided with a through-hole 60h in a bottom surface, provided on the substrate 10 to locate the light-emitting section 20 in the through-hole 60h, and made of an insulating member, a cylindrical reflector 70 housed in the outer frame body 60. The reflector 70 includes a first opening end 701 and a second opening end 702 having an area larger than the area of the first opening end 701. The reflector 70 is provided on the bottom surface with the first opening end 701 directed to the bottom surface side of the outer frame body 60. The inner surface of the reflector 70 has at least electrical conductivity.

A step is absent between an inner wall surface 60w of the through-hole 60h and an inner wall surface 70w of the reflector 70. “A step is absent” means a state in which there is no level difference in a direction perpendicular to the inner wall surface 60w and the inner wall surface 70w between the inner wall surface 60w and the inner wall surface 70w in a portion where the inner wall surface 60w and the inner wall surface 70w are in contact with each other. The inner wall surface 60w of the through-hole 60h and the inner wall surface 70w of the reflector 70 may be configured to have no step over the entire circumferences thereof or may have a portion where the inner wall surface 60w and the inner wall surface 70w are not in contact. For example, in the positions of a connector and the like mounted on the substrate 10, cutouts may be provided in both or one of the inner wall surface 60w and the inner wall surface 70w to avoid the connector and the like. The area of a third opening end 601 on the substrate 10 side of the through-hole 60h is smaller than the area of a fourth opening end 602 on the reflector 70 side of the through-hole 60h. That is, the inner wall surface 60w expands from the third opening end 601 to the fourth opening end 602. “The area of the opening end” means an opening area of the opening end viewed from a direction perpendicular to the substrate 10.

Details of the luminaire are explained below.

The light-emitting section 20 includes light-emitting elements. In the light emitting section 20, for example, a plurality of light-emitting elements such as LEDs (Light Emitting Diodes) are provided in parallel. The luminaire according to this embodiment is not limited to a luminaire including LEDs as light-emitting elements. Luminaires including light-emitting elements such as an EL (Electro-Luminescence) and an organic light-emitting diode (OLED) besides the LEDs are included in the scope of this embodiment. The substrate 10 and the light-emitting section 20 are sometimes collectively referred to as LED module.

The outer frame body 60 includes a bottom surface section 60b and a side surface section 60sw. In the center of the bottom surface section 60b, as an example, the through-hole 60h circular in a plane is provided. The outer frame body 60 is provided on the substrate 10 to locate the light-emitting section 20 in the through-hole 60h. In other words, the inner wall of the through-hole 60h stands on the outer circumference of the light-emitting section 20. The material of the outer frame body 60 is desirably a material having high insulation. For example, as the material of the outer frame body 60, white PBT (polybutylene terephthalate) resin is desirable.

The reflector 70 is housed in the outer frame body 60 and formed in a cylindrical shape. The reflector 70 includes the first opening end 701 and the second opening end 702 having an inner diameter larger than the inner diameter of the first opening end 701. The reflector 70 is provided on the bottom surface section 60b with the first opening end 701 directed to the bottom surface section 60b side. The inner wall surface 70w of the reflector 70 is covered with a metal film of aluminum (Al), nickel (Ni), or the like. The inner wall surface 70w is formed in a curved surface shape.

The luminaire 1 includes a thermal radiator 15 made of metal (e.g., aluminum (Al)). The thermal radiator 15 supports the substrate 10. Heat emitted by the light-emitting section 20 is discharged to the thermal radiator 15. The thermal radiator 15 is fixed to the outer frame body 60 by a fixing member (not shown) according to necessity. The fixing member is, for example, a metal screw. A circuit board 30 is provided above the thermal radiator 15 with a predetermined distance apart from the thermal radiator 15 and the light-emitting section 20. The circuit board 30 is supported from the lower side by the thermal radiator 15 and the outer frame body 60 and supported from the upper side by the reflector 70.

The luminaire 1 includes electronic components 40. When a principal plane of the circuit board 30 opposed the thermal radiator 15 is represented as first principal plane 30a and a principal plane of the circuit board 30 on the opposite side of the first principal plane 30a is represented as second principal plane 30b, the electronic components 40 are mounted on, for example, the second principal plane 30b. On the first principal plane 30a and the second principal panel 30b of the circuit board 30, circuit patterns 35 made of metal (e.g., copper (Cu)) is formed. The electronic components 40 are, for example, a coil, a transformer, a diode, a transistor, a resistor, and a capacitor.

The outer frame body 60 houses the light-emitting section 20, the circuit board 30, and the electronic components 40. The bottom surface section 60b of the outer frame body 60 is interposed between the thermal radiator 15 and the circuit board 30. The bottom surface section 60b is in contact with the thermal radiator 15. That is, a part of the thermal radiator 15 is in contact with the outer side of the outer frame body 60.

In the luminaire 1, the substrate 10 is fixed to the thermal radiator 15 by the outer frame body 60. The substrate 10 is pressed by the outer frame body 60 in a surface contact manner. Therefore, a resist (not shown in the figure) formed on the substrate 10 is less easily damaged. Further, to prevent the resist from being damaged, a material softer than the material of the reflector 70 may be selected as the material of the outer frame body 60.

Besides, the luminaire 1 includes a translucent shield member 80 and an electrode pin 11 arranged on the outer circumference of the thermal radiator 15. Since the reflector 70 is provided, the electronic components 40 are arranged in a space 95 surrounded by the circuit board 30, the outer frame member 60, and the reflector 70. The translucent shield member 80 is provided to cover the reflector 70 and the light-emitting section 20. The translucent shield member 80 transmits light emitted from the light-emitting section 20 and protects the light-emitting section 20. The electrode pin 11 functions as an electrode for supplying electric power to the electronic components 40, an electrode for supplying a signal for dimming, an electrode for ground, or the like. The electrode pin 11 and the thermal radiator 15 are sometimes collectively referred to as cap 12.

If the luminaire 1 is viewed from the direction perpendicular to the substrate 10, the external shape of the light-emitting section 20 is rectangular and the external shape of the thermal radiator 15 and the external shape of the circuit board 30 are substantially circular. The outer diameter of the light-emitting section 20 is smaller than the outer diameter of the thermal radiator 15 and the outer diameter of the circuit board 30. The outer diameter of the thermal radiator 15 is smaller than the outer diameter of the circuit board 30.

In FIGS. 2A and 2B, a state in which the translucent shield member 80 is placed on the upper side and the thermal radiator 15 is placed on the lower side is illustrated. However, the translucent shield member 80 may be placed on the lower side and the thermal radiator 15 may be placed on the upper side.

FIG. 4 is a schematic plan view of the luminaire according to the first embodiment.

In FIG. 4, a plane of the reflector 70, the outer frame body 60, and the light-emitting section 20 viewed from the direction perpendicular to the substrate 10 is shown.

If the luminaire 1 is viewed from a direction perpendicular to the principal plane of the substrate 10, a center 60c of the through-hole 60h and a center 70c of the first opening end 701 coincide with each other. The inner diameter of the third opening end 601 on the substrate 10 side of the through-hole 60h is smaller than the inner diameter of the fourth opening end 602 on the reflector 70 side of the through-hole 60h. The inner diameter of the fourth opening end 602 of the through-hole 60h and the inner diameter of the first opening end 701 of the reflector 70 are substantially equal. The area of the fourth opening end 602 of the through-hole 60h and the area of the first opening end 701 of the reflector 70 are substantially equal. The planar shape of the first to fourth opening ends are circular. However, the planar shape may be polygonal.

As shown in FIG. 3, the substrate 10 and the outer frame body 60 are in contact with each other without a gap. The bottom surface section 60b of the outer frame body 60 and the reflector 70 are in contact with each other without a gap. “In contact with each other without a gap” means that the substrate 10 and the outer fame body 60 (or the bottom surface section 60b and the reflector 70) are in contact with each other without being spaced apart from each other. A step is absent between the inner wall surface 60w of the through-hole 60h and the inner wall surface 70w of the reflector 70.

Light emitted from the light-emitting section 20 reaches the translucent shield member 80, the inner wail surface 70w of the reflector 70, or the inner wall surface 60w of the through-hole 60h. The light directly reaching the translucent shield member 80 is emitted to the outside of the luminaire 1 from the translucent shield member 80. The light reaching the inner wall surface 60w of the through-hole 60h or the inner wall surface 70w of the reflector 70 is reflected by the inner wall surface 60w or the inner wall surface 70w. The light reaches the translucent shield member 80 soon. Thereafter, the light is emitted to the outside of the luminaire 1 from the translucent shield member 80.

In the luminaire 1, in a direction from the substrate 10 side to the reflector 70 side, a distance L from the third opening end 601 of the through-hole 60h to the fourth opening end 602 of the through-hole 60h is desirably equal to or larger than 1 mm and equal to or smaller than 2 mm. If the distance L is smaller than 1 mm, it is likely that mechanical strength of the bottom surface section 60b is not maintained. Further, if the distance L is smaller than 1 mm, it is likely that the metal film covering the inner wall surface 70w of the reflector 70 is close to the substrate 10 and insulation between the reflector 70 and the substrate 10 is not maintained. If the distance L is larger than 2 mm, it is likely that the reflector 70 is apart from the light-emitting section 20 and light extracting efficiency is deteriorated. Therefore, the distance L is desirably equal to or larger than 1 mm and equal to or smaller than 2 mm.

### Reference Example

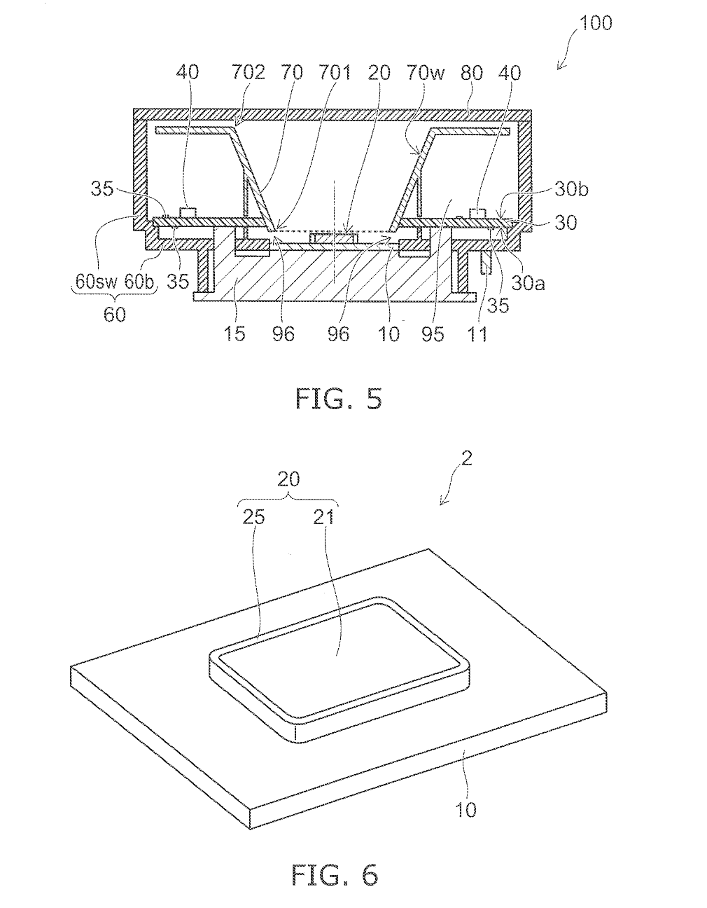

FIG. 5 is an enlarged schematic sectional view of the vicinity of a light-emitting section of a luminaire according to a reference example. In FIG. 5, an enlarged state of the vicinity of the light-emitting section of the luminaire is shown.

In a luminaire 100 according to the reference example, the inner wall surface 60w of the through-hole 60h is not provided on the outer circumference of the light-emitting section 20. That is, a gap 96 is present between the substrate 10 and the reflector 70. In the luminaire 100, since the gap 96 is present, a spatial distance between the metal film on the inner wall of the reflector 70 and the substrate 10 is secured and insulation between the substrate 10 and the reflector 70 is secured.

However, the light emitted from the light-emitting section 20 leaks from the gap 96 and light extracting efficiency of the luminaire 100 is deteriorated.

On the other hand, with the luminaire 1 according to this embodiment, the outer circumference of the substrate 10 of the LED module is pressed by the insulative outer frame body 60 and the reflector 70 is in contact with the upper side of the outer frame body 60. Consequently, the insulation between the substrate 10 of the LED module and the reflector 70 is maintained. Further, the light emitted from the light-emitting section 20 can be efficiently emitted to the translucent shield member 80 side. As a result, the light extracting efficiency of the luminaire 1 is further improved.

The substrate 10 and the outer frame boy 60 are in contact with each other without a gap and the outer frame body 60 and the reflector 70 are in contact with each other without a gap. Consequently, the light emitted from the light-emitting section 20 can be efficiently emitted to the translucent shield member 80 side.

Since the distance L from the third opening end 601 of the through-hole 60h to the fourth opening end 602 of the through-hole 60h is equal to or larger than 1 mm and equal to or smaller than 2 mm, the spatial distance between the substrate 10 of the LED module and the reflector 70 is surely secured and the deterioration in the light extracting due to light absorption by the outer frame 60 is minimized. When PBT resin was used as the material of the outer frame body 60, in the luminaire 1, an amount of light increased 5% compared with the luminaire 100.

In a luminaire 2 in which the transparent resin was used as the material of the outer frame body 60, an amount of light increased 5% or more.

### Second Embodiment

FIG. 6 is a schematic perspective view of the vicinity of a light-emitting section of a luminaire according to a second embodiment.

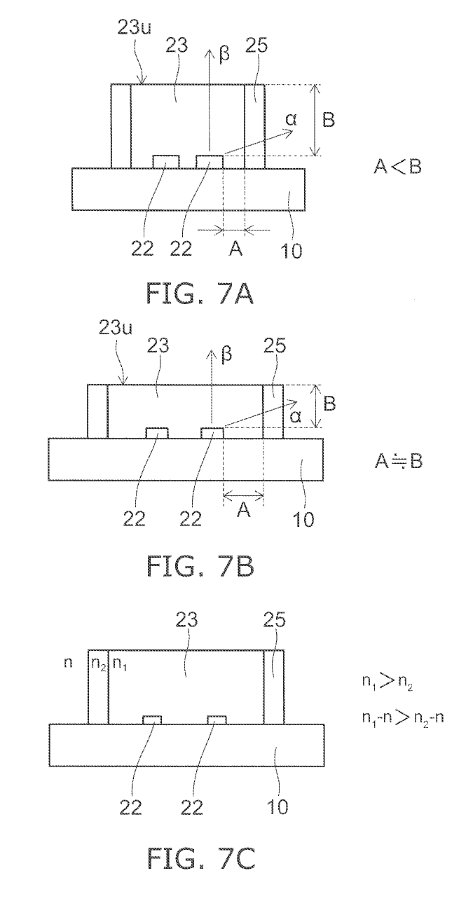

FIG. 7A is a schematic sectional view of a first example of the vicinity of the light-emitting section of the luminaire. FIG. 7B is a schematic sectional view of a second example of the vicinity of the light-emitting section of the luminaire. FIG. 7C is a schematic sectional view of a third example of the vicinity of the light-emitting section of the luminaire.

In FIG. 6 and FIGS. 7A to 7C, the vicinity of the light-emitting section 20 of the luminaire 2 according to the second embodiment is shown. The structure of the luminaire 2 other than the structure shown in FIG. 6 and FIGS. 7A to 7C are the same as the structure of the luminaire 1.

As shown in FIG. 6, the light-emitting section 20 is provided on the substrate 10. The light-emitting section 20 includes a light emission section 21 and a wall-like translucent resin section 25 that surrounds the outer circumference of the light emission section 21. Further, as shown in FIGS. 7A, to 7C, the light emission section 21 includes LED elements 22 (light-emitting elements) and phosphor-containing resin 23 that covers the LED elements 22.

It is assumed that the material of the resin section 25 includes a material non-transmissive to lights emitted from the LED elements 22. In this case, if the lights emitted from the LED elements 22 hit the resin section 25, thereafter, the lights are reflected by the resin section 25 to the phosphor-containing resin 23 side. Therefore, the light extracting efficiency of the light-emitting section 20 is, so to speak, reaches a peak.

On the other hand, if the material of the resin section 25 includes a material transmissive to the lights emitted from the LED elements 22 as shown in FIGS. 7A to 7C, there are advantages explained below. Examples of the light transmissive material include polycarbonate resin, ABS resin, polystyrene resin, acrylic resin, and polyethylene rein.

For example, in FIG. 7A, a distance B between the LED elements 22 and an upper surface 23u of the phosphor-containing resin 23 is larger than a distance A between the LED element. 22 and the resin section 25. In this case, light α emitted from the LED element 22 passes through the resin section 25. Therefore, it is possible to efficiently extract light from the light-emitting section 20.

However, in an example shown in FIG. 7A, as explained above, the distance B is set larger than the distance A. Therefore, the distance A is relatively small and the light α traveling from the LED element 22 to the resin section 25 travels a short distance in the phosphor-containing resin 23. Consequently, if a color conversion amount of light β is optimized, the color conversion amount of the light α is likely to be insufficient. The distance B is relatively large. Therefore, the light β traveling from the LED element 22 to the upper surface 23u of the phosphor-containing resin 23 travels a long distance in the phosphor-containing resin 23. Consequently, when the color conversion amount of the light α is optimized, the light β is excessively converted in color.

On the other hand, in FIG. 7B, the distance A between the LED elements 22 and the resin section 25 and the distance B between the LED elements 22 and the upper surface 23u of the phosphor-containing resin 23 is set substantially equal. In such a state, the lights α and β travel substantially equal distances in the phosphor-containing resin 23. Therefore, it is unlikely that the color conversion amount of the light α is insufficient and the light β is excessively converted in color.

In FIG. 7C, a refractive index n1 of the phosphor-containing resin 23 is designed higher than a refractive index n2 of the resin section 25. Consequently, a difference between the refractive index n1 and a refractive index n of the air is larger than a difference between the refractive index n2 and the refractive index n of the air. Total reflection of light in the resin section 25 less easily occurs. As a result, it is possible to more efficiently extract the light from the light-emitting section 20.

The embodiments are explained above with reference to the specific examples. However, the embodiments are not limited to the specific examples. That is, the specific examples subjected to design change as appropriate by those skilled in the art are also included in the scope of the embodiments as long as the specific examples include the characteristics of the embodiments. The components included in the specific examples and the arrangements, the materials, the conditions, the shapes, the sizes, and the like of the components are not limited to the illustrated ones and can be changed as appropriate.

The components included in the embodiments can be combined as long as the combination is technically possible. The combined components are also included in the scope of the embodiments as long as the combined components include the characteristics of the embodiments. Besides, those skilled in the art can conceive of various modifications and alterations within the category of the idea of the embodiments. It is understood that the modifications and alterations are also included in the scope of the embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A luminaire comprising:
a substrate;
a light-emitting section mounted on the substrate, the light-emitting section including a light-emitting element;
an outer frame body provided with a through-hole in a bottom surface, the outer frame body being provided on the substrate so as to locate The light emitting section in the through-hole, and the outer frame body being made of an insulating member; and
a cylindrical reflector housed in the outer frame body, the cylindrical reflector including a first opening end and a second opening end, the second opening end having an area larger than an area of the first opening end, and the cylindrical reflector provided on the bottom surface with the first opening end directed to the bottom surface side,
a step being absent in at least one part of the part between an inner wall surface of the through-hole and an inner wall surface of the reflector, and
an area of a third opening end on the substrate side of the through-hole being smaller than an area of a fourth opening end on the reflector side of the through-hole.

2. The luminaire according to claim 1, wherein the substrate and the outer frame body are in contact with each other without a gap.

3. The luminaire according to claim 1, wherein the bottom surface of the outer frame body and the reflector are in contact with each other without a gap.

4. The luminaire according to claim 2, wherein the bottom surface of the outer frame body and the reflector are in contact with each other without a gap.

5. The luminaire according to claim 1, wherein
at least an inner surface of the reflector has electrical resistivity, and
a distance from the third opening end of the through-hole to the fourth opening end of the through-hole in a direction from the substrate side to the reflector side is equal to or larger than 1 mm and equal to or smaller than 2 mm.

6. The luminaire according to claim 2, wherein
at least an inner surface of the reflector has electrical resistivity, and
a distance from the third opening end of the through-hole to the fourth opening end of the through-hole in a direction from the substrate side to the reflector side is equal to or larger than 1 mm and equal to or smaller than 2 mm.

7. The luminaire according to claim 3, wherein
at least an inner surface of the reflector has electrical resistivity, and
a distance from the third opening end of the through-hole to the fourth opening end of the through-hole in a direction from the substrate side to the reflector side is equal to or larger than 1 mm and equal to or smaller than 2 mm.

8. The luminaire according to claim 4, wherein
at least an inner surface of the reflector has electrical resistivity, and
a distance from the third opening end of the through-hole to the fourth opening end of the through-hole in a direction from the substrate side to the reflector side is equal to or larger than 1 mm and equal to or smaller than 2 mm.

9. The luminaire according to claim 1, wherein the light-emitting section includes:
a light emission section configured to emit light; and
a resin section having translucency configured to surround the light emission section.

10. The luminaire according to claim 2, wherein the light-emitting section includes:
a light emission section configured to emit light; and
a resin section having translucency configured to surround the light emission section.

11. The luminaire according to claim 3, wherein the light-emitting section includes:
a light emission section configured to emit light; and
a resin section having translucency configured to surround the light emission section.

12. The luminaire according to claim 4, wherein the light-emitting section includes:
a light emission section configured to emit light; and
a resin section having translucency configured to surround the light emission section.

13. The luminaire according to claim 5, wherein the light-emitting section includes:
a light emission section configured to emit light; and
a resin section having translucency configured to surround the light emission section.

14. The luminaire according to claim 6, wherein the light-emitting section includes:
a light emission section configured to emit light; and
a resin section having translucency configured to surround the light emission section.

15. The luminaire according to claim 7, wherein the light-emitting section includes:
a light emission section configured to emit light; and
a resin section having translucency configured to surround the light emission section.

16. The luminaire according to claim 8, wherein the light-emitting section includes:
a light emission section configured to emit light; and
a resin section having translucency configured to surround the light emission section.

17. The luminaire according to claim 9, wherein
the light emission section includes the light-emitting element and phosphor-containing resin configured to cover the light-emitting element, and
a distance between the light-emitting element and the resin section and a distance between the light-emitting element and an upper surface of the phosphor-containing resin is substantially equal.

18. The luminaire according to claim 10, wherein
the light emission section includes the light-emitting element and phosphor-containing resin configured to cover the light-emitting element, and
a distance between the light-emitting element and the resin section and a distance between the light-emitting element and an upper surface of the phosphor-containing resin is substantially equal.

19. The luminaire according to claim 11, wherein
the light emission section includes the light-emitting element and phosphor-containing resin configured to cover the light-emitting element, and
a distance between the light-emitting element and the resin section and a distance between the light-emitting element and an upper surface of the phosphor-containing resin is substantially equal.

20. The luminaire according to claim 17, wherein a refractive index of the phosphor-containing resin is higher than a refractive index of the resin section.
